(19) United States
(12) Patent Application Publication
(10) Pub. No.: US 2015/0130849 A1
(43) Pub. Date: May 14, 2015

(54) APPARATUS FOR IMAGE MANIPULATION AND ANALYSIS ON PAIRED IMAGES IN FIBER OPTIC TEST

(71) Applicant: AFL TELECOMMUNICATION LLC, Duncan, SC (US)

(72) Inventors: William Henry Thompson, Westborough, MA (US); Christopher Theberge, Concord, NH (US); Joseph P. Mercurio, Nashua, NH (US); Sean P. Adam, Wrentham, MA (US); Joseph Fitzgerald, Concord, NH (US); Michael Leighton, Deerfield, NH (US)

(73) Assignee: AFL TELECOMMUNICATIONS LLC, Duncan, SC (US)

(21) Appl. No.: 14/381,485

(22) PCT Filed: Mar. 12, 2013
(86) PCT No.: PCT/US13/30507

§ 371 Date: Aug. 27, 2014

Related U.S. Application Data
(60) Provisional application No. 61/609,544, filed on Mar. 12, 2012.

(51) Int. Cl. G01M 11/02; G06T 3/40; G09G 5/00; G06T 3/20

(52) U.S. Cl. CPC G01M 11/0257; G06T 3/20; G06T 3/40; G09G 5/003; G09G 2340/045; G09G 2340/0464
USPC 345/667; 345/522; 345/684

(57) ABSTRACT

An optical fiber inspection apparatus including a memory configured to store a pair of images of ends of optical fibers, a display, and a processor coupled to the memory and the display, wherein the processor controls the display to display the pair of images simultaneously.

### CROSS-REFERENCE TO RELATED APPLICATIONS

This application is based upon and claims the benefit of priority from U.S. Provisional Application No. 61/609,544, filed Mar. 12, 2012, in the United States Patent and Trademark Office, the disclosures of which are incorporated herein in its entirety by reference.

### BACKGROUND

1. Field

The invention is related to an apparatus for inspecting the ends of optical fibers, and more particularly, to an apparatus for inspecting the end of optical fibers that can display a pair of images of ends of optical fibers.

2. Related Art

Fiber and connector contamination is a key contributor to network downtime and there is a need to document that fibers and connectors have been properly cleaned during installation and subsequent network activation and maintenance tasks. Typically, technicians are given very basic tools, such as miniature optical microscopes or crude video microscopes to perform inspections but these can neither document results nor provide pass/fail analysis. Thus, some fibers may not be inspected at all and those that are inspected could be subject to the arbitrary decisions of field technicians.

Existing technology does not allow users to achieve linkage between connector images of interest for reporting or analysis needs. This limits the image usefulness to the user and places undue burden on users to manually associate images or manually review images for differences. Often images of interest are taken either weeks/months apart (in case of identical end-face and determination/documentation of reason service interruption) or taken from geographically different locations (in case of certifying a fiber installation where documentation of both ends of fiber is critical).

Therefore, it is an object of the invention to be able to capture and review pairs of images in order to simplify before/after, jumper/bulkhead, input/output, near/far, as built/as found and other common fiber cleanliness comparison.

Another object of the invention is to provide the capability to manipulate, analyze and annotate pairs of images.

### SUMMARY

Exemplary implementations of the present invention address at least the above problems and/or disadvantages and other disadvantages not described above. Also, the present invention is not required to overcome the disadvantages described above, and an exemplary implementation of the present invention may not overcome any of the problems listed above.

An embodiment of the invention is an optical inspection apparatus for including a memory configured to store a pair of images of ends of optical fibers, a display, and a processor coupled to the memory and the display, wherein the processor controls the display to display the pair of images simultaneously.

Other features of the embodiment may include the processor controlling the display to manipulate both images simultaneously and the processor controlling the display to annotate both images simultaneously. The manipulation may be at least one of a zoom or pan.

Other features of the embodiment may include the processor controlling the display to manipulate only one of the images and the processor controlling the display to annotate only one of the images.

Other features of the embodiment may include the processor performing an analysis on both images and controlling the display to display results of the analysis.

Other features of the embodiment may include storing a program on a non-transitory computer readable medium to perform the functions described above and in the detailed description section below.

### BRIEF DESCRIPTION OF THE DRAWING

FIG. 1 shows an exemplary embodiment of an apparatus for inspecting optical fibers.

FIG. 2 shows an exemplary functional block diagram of an embodiment of an apparatus for inspecting optical fibers.

FIGS. 3A-3B show an exemplary live image mode of an embodiment of an apparatus for inspecting optical fibers.

FIGS. 4A-4B show an exemplary image capture mode of an embodiment of an apparatus for inspecting optical fibers.

FIGS. 5A-5B show an exemplary analysis mode of an embodiment of an apparatus for inspecting optical fibers.

FIGS. 5C-5F show exemplary analysis results of an embodiment of an apparatus for inspecting optical fibers.

FIGS. 6A-6E show an exemplary image review mode of an embodiment of an apparatus for inspecting optical fibers.

FIG. 7 shows an exemplary algorithm for implementing analysis, manipulation and/or annotation of a pair of images.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

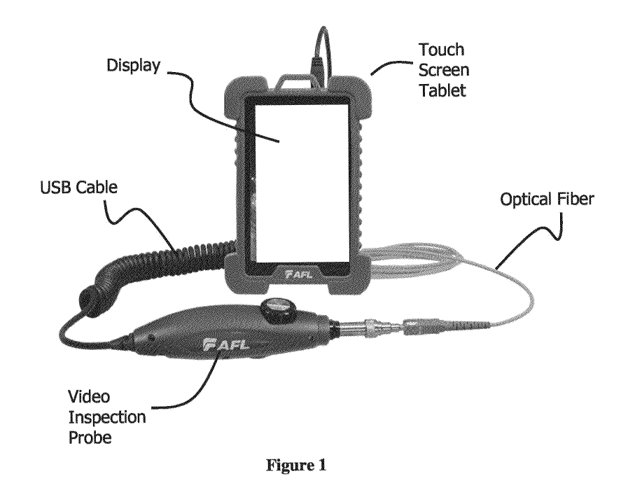

FIG. 1 shows an exemplary embodiment of an apparatus for inspecting optical fibers according to an exemplary embodiment of the invention. The apparatus may include a touchscreen tablet with a display. The tablet may be a purpose-built Windows computer equipped with appropriate software. However, other platforms, including, but not limited to, hand held displays, optical test equipment (e.g., optical time-domain reflectometers (OTDRs), optical power meters (OPMs), optical spectrum analyzers (OSAs)), personal computers and smart phones running, operating systems including, but not limited to, Windows, Android, Linux and IOS. An exemplary touchscreen tablet is the AFL DFD1.

In one embodiment, the software analyzes a typical fiber in under five seconds and is capable of centering a fiber image, identifying critical core, cladding, adhesive and contact zones and detecting and tallying the types of defects found. The display provides detailed images and a zoom/pan feature allows the user to identify the smallest particles, scratches and imperfections. Portrait orientation makes it easy to hold and operate with just one hand. Another feature is an image pairing feature, which simplifies before/after, jumper/bulkhead, input/output, near/far, as built/as found and other common fiber cleanliness comparisons. Additional features include image capture and store/recall. In one embodiment up to 1000 fiber images may be stored in on-board memory and images may be transferred via any off-the-shelf USB memory stick, SD flash card. or other memory device.

A video inspection probe is used to capture images of ends of optical fibers. An exemplary video inspection probe is the AFL DFS 1 Digital FiberScope, which is a high resolution video inspection probe. It is equipped with a focusing knob and an image capture button. An assortment of DFS 1 adapter tips allow it to be used with all types of fiber connector ferrules and bulkhead connectors. Bulkhead tips are available in multiple lengths as well as straight and 60° angle. Connector adapters are available in PC/UPC, APC polished ferrule in 1.25 mm, 2.5 mm, MPO connectors and many more. FIG. 1 shows an optical cable connected to the video inspection probe. The video inspection probe may be connected to the touchscreen tablet by a USB cable.

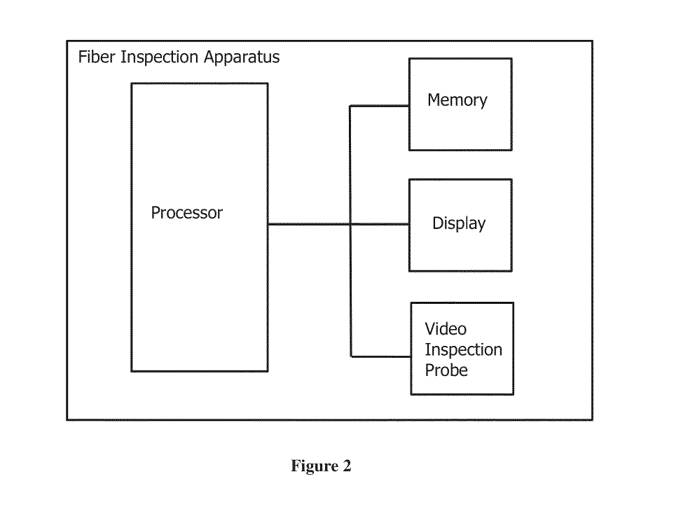

FIG. 2 shows an exemplary functional block diagram of the fiber inspection apparatus. It includes a processor, memory, display and video inspection probe. An example of a processor is an ARM Xscale 806Mhz processor. An example of a memory is a 8 Gbit NAND flash memory. An example of a display is a 3.5 inch QVGA panel. The processor, under the control of the operating software, controls the operation of the apparatus, including displaying images on the display. The memory stores the operating software and images that are captured by the video inspection probe. The operating software can also be stored on a non-transitory computer readable medium. In addition, the processor is capable of producing and outputting reports via an output port (not shown).

Next, exemplary operation of the fiber inspection apparatus will be described. The operation assumes the video inspection probe is configured with the appropriate adapter tip installed, the touchscreen tablet is powered up, the video inspection probe is connected to the touchscreen tablet, and real-time images from the video inspection probe are currently being displayed on the display.

If testing an optical fiber connector, the ferrule of the optical fiber is slid into the installed adapter probe tip, using caution not to contaminate the end-face of the fiber connector. A dark circle will appear on the attached device display.

If testing an optical fiber connector mounted in a bulkhead adapter, the probe adapter tip is slid into the bulkhead adapter. The angle of the adapter tip is adjusted until a dark circle appears on the attached device display.

Next, the focus adjust knob on the video inspection probe is rotated clockwise or counter-clockwise until the displayed circle is in sharp focus. Once a good image has been obtained, it may be analyzed in several ways: (1) live image mode—allows focusing the image and inspecting the condition of the connector end-face; (2) analysis mode—generates a static image of the connector and enables automatic analysis according to the analysis criteria selected by the user, allows viewing analysis criteria and the resulted image using zoom and pan tools and allows the user either to store or delete the captured image; and (3) image capture mode—features viewing the captured image using zoom and pan tools, allows the user either to store or delete the captured image. After either saving or deleting the captured image, the touchscreen tablet transitions to the live image mode.

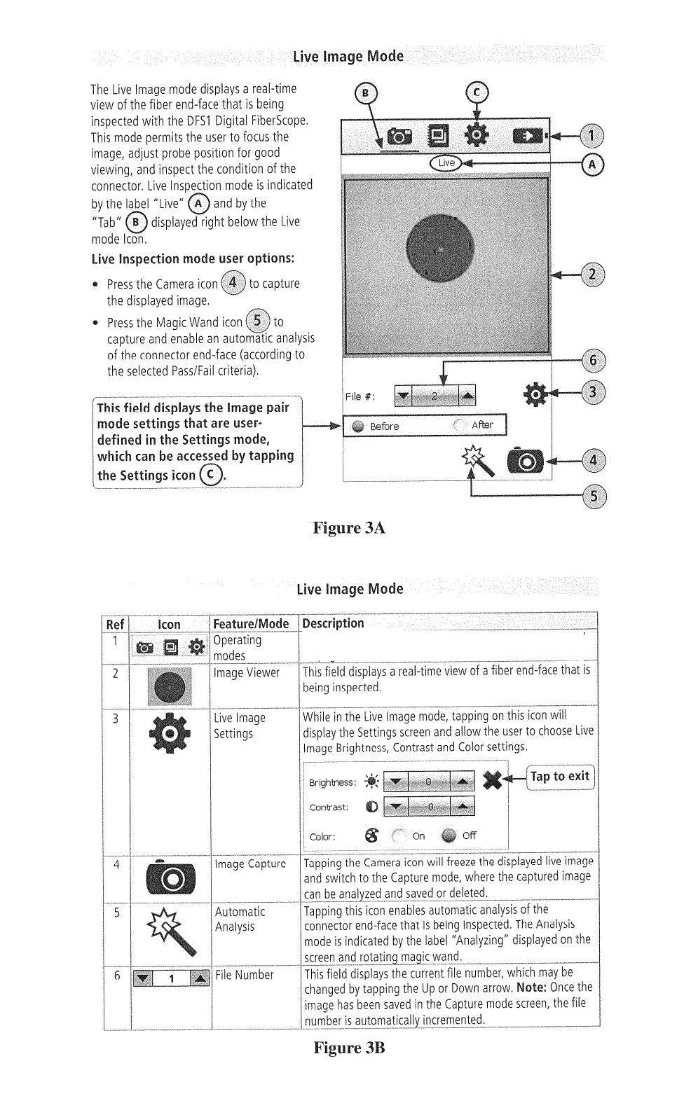

FIGS. 3A-3B show an exemplary live image mode of an embodiment of fiber inspection apparatus. The live image mode displays a real-time view of the fiber end-face that is being inspected with the video inspection probe. This mode permits the user to focus the image, adjust probe position for good viewing, and inspect the condition of the connector. The live image mode contains a field that allows for the selection of image pair mode.

Enabling the image pair mode allows the user to select a preset pairing mode prior to fiber inspection, then inspect fiber end-faces and save captured images with the selected pairing preset label for simplified identification, recall, and review. To use the image pair mode, a preset image pairing mode is set prior to fibers inspection. Examples of image pair presets include: (1) Before/after—This is a general preset for any before/after fiber inspection comparisons; (2) Input/output—This is a general preset for any input/output fiber inspection comparison; (3) Cleaning—This preset is used for inspection fiber end-faces before and after cleaning; (4) Mating—This preset is used for inspection of mating connector and bulkhead; and (5) Documentation—This preset is used for as-built/as-found fiber installation and maintenance.

After the image pair mode is enabled, captured images are stored with the selected pairing mode label (Before/After, Input/Output, Cleaning, Mating, Documentation) for image pair identification. To simplify images recall and review, stored images may be optionally filtered by the user-selected image pair mode.

FIG. 3B describes some of the features of the live image mode.

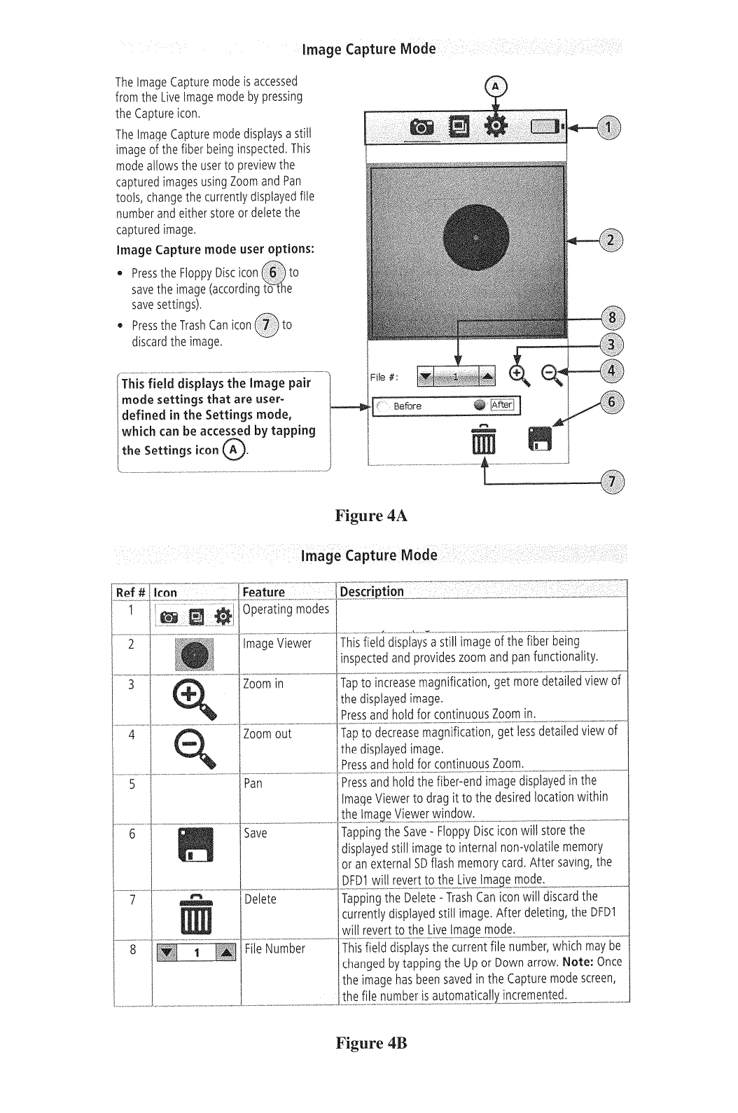

FIGS. 4A-4B show an exemplary image capture mode of an embodiment of an apparatus for inspecting optical fibers. The image capture mode displays a still image of the fiber being inspected. This mode allows the user to preview the captured images using zoom and pan tools, change the currently displayed file number and either store or delete the captured image. FIG. 4B describes some of the features of the image capture mode.

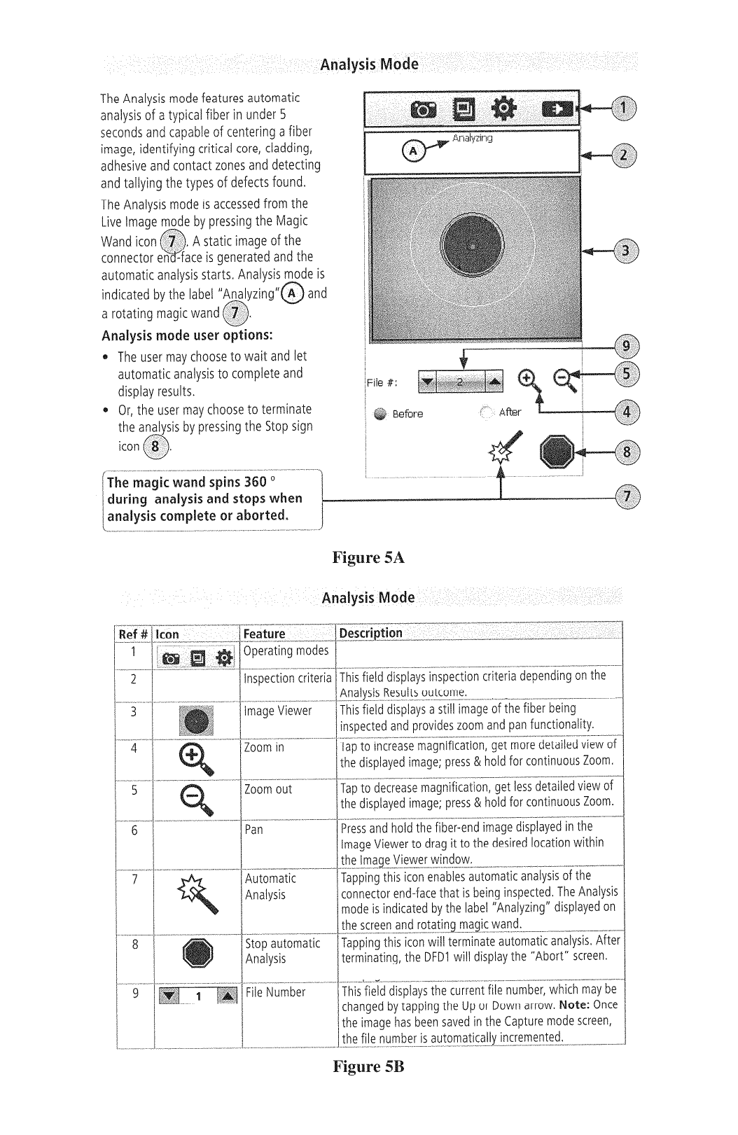

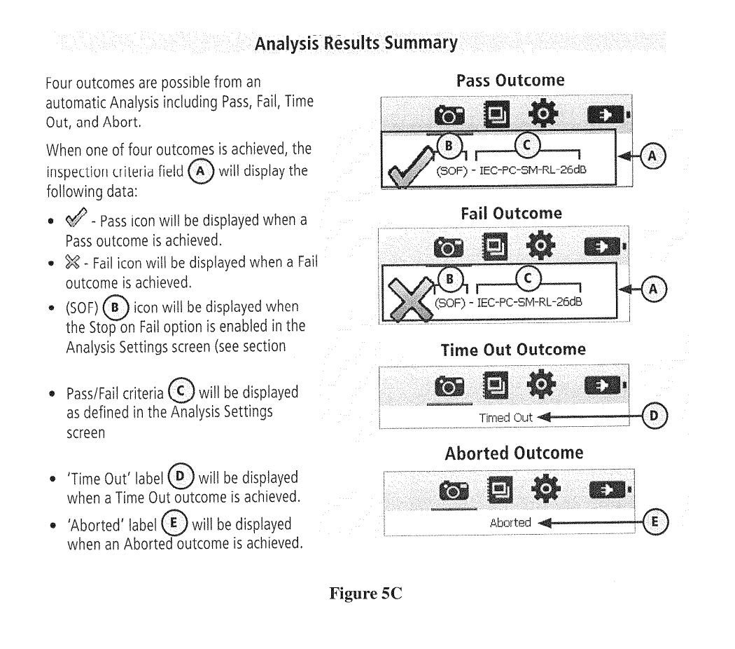

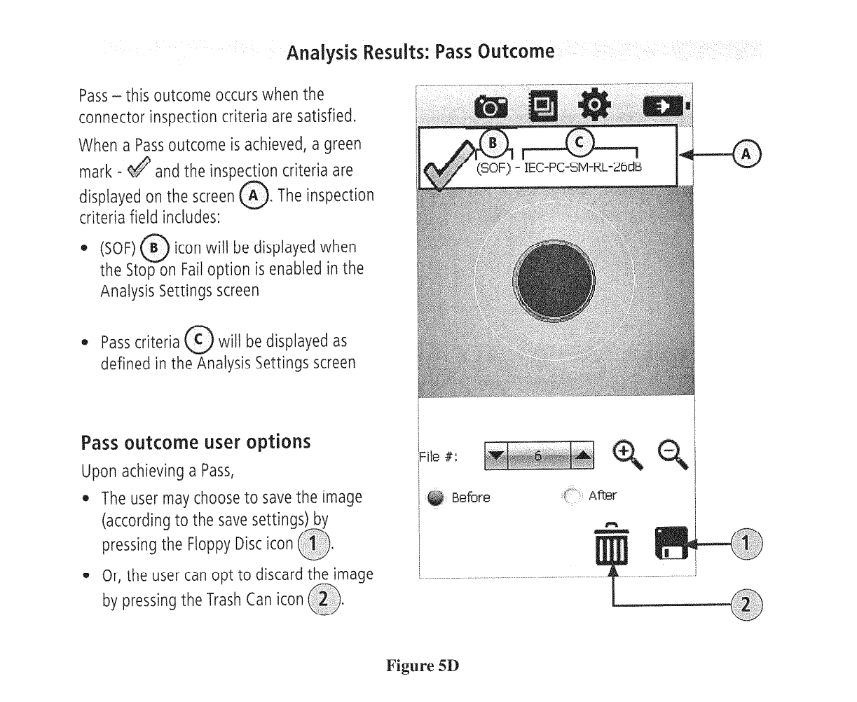

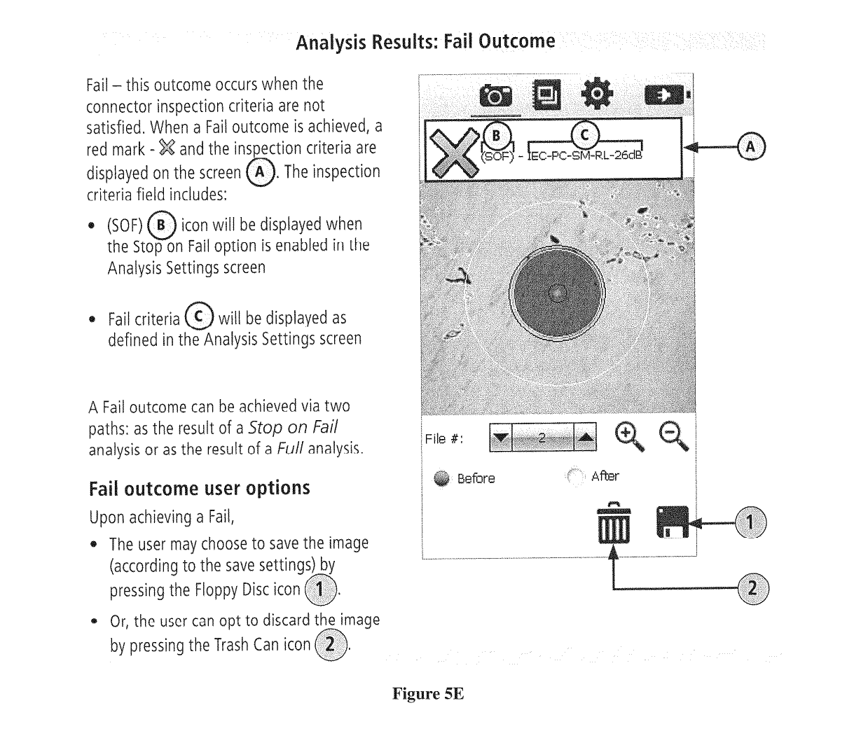

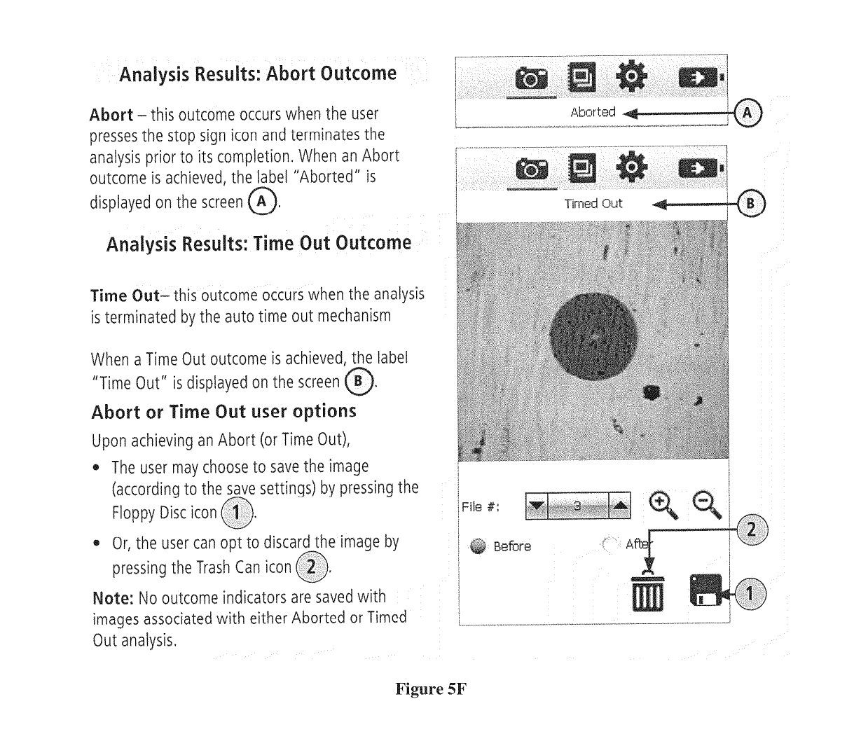

FIGS. 5A-5B show an exemplary analysis mode of an embodiment of an apparatus for inspecting optical fibers. The analysis mode features automatic analysis of a typical fiber in under five seconds and capable of centering a fiber image, identifying critical core, cladding, adhesive and contact zones and detecting and tallying the types of defects found. The analysis can be performed to industry standard criteria, such as IEC 61300-3-35 and AT&T TP-76461, or can be user-defined.

FIG. 5B describes some of the features of the analysis mode. Although only one image is shown in this figure, a pair of images can also be analyzed and compared. When two images are analyzed, it is possible to identify differences between two images.

FIGS. 5C-5F show exemplary analysis results of an embodiment of an apparatus for inspecting optical fibers. Although only one image is show in these figures, results from the analysis of a pair of images can also be shown. Thus, it is possible to automatically identify image analysis differences between paired images (e.g., identifying specific defects/abnormalities that are different between images).

The apparatus also is capable of producing documentation and reports, such as customer certification reports, that show the results of the analysis of a pair of images. For example, the processor can output a report that has a “before cleaning” image and analysis results (such as defects and abnormalities), and an “after cleaning” image and analysis results. Likewise, a report that has an image and analysis of a mating bulkhead end-face and an image and analysis of a corresponding jumper cable end-face can be produced. The paired analysis results can also be combined with other data associated with the optical fibers, such as OTDR, OPM and OSA test data.

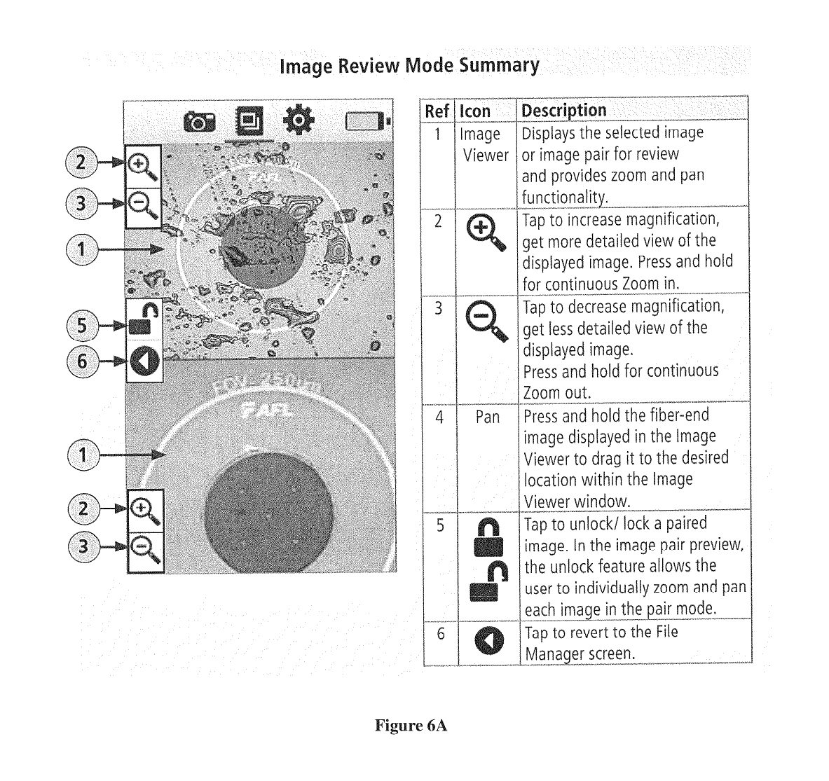

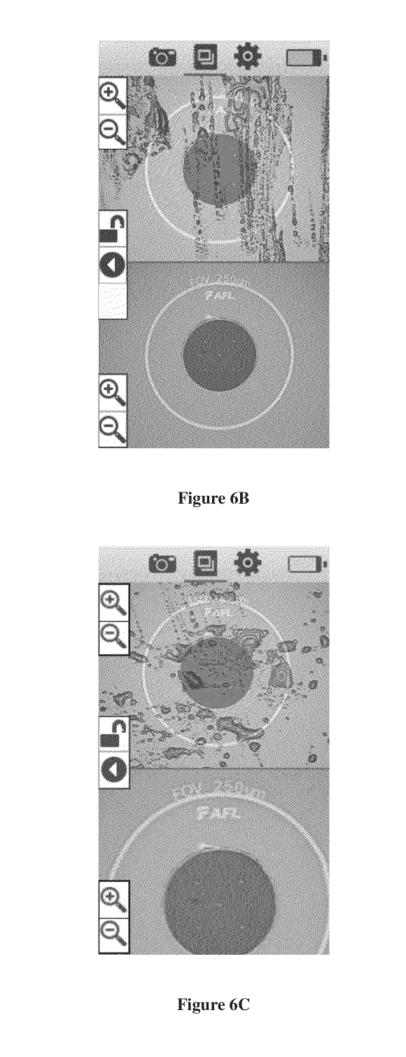

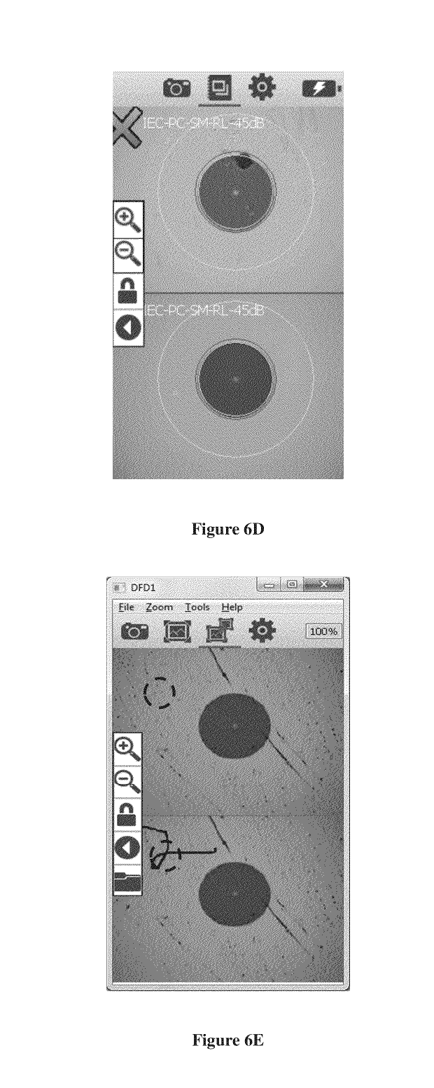

FIG. 6A shows an exemplary image review mode of an embodiment of an apparatus for inspecting optical fibers. In this figure, an image pair is displayed. In the image review mode, the images can be enlarged and reduced in size (zoom), and panned The pair of images can be manipulated individually (if the images are unlocked) or together (if the images are locked). “Unlocked images” can also be re-paired to the same settings. For example, FIG. 6A shows unlocked images with different sizes. FIGS. 6B and 6C show unlocked images before one of the images is enlarged and after one of the images is enlarged. FIG. 6D shows an example of locked images that have been analyzed.

FIG. 6E shows an example of an annotation feature. For example, a dashed lined circle can be used to manually add an abnormality indication to image pair. This annotation can be added on each image individually, or on simultaneously on both images by placing the mark on one of the images.

FIGS. 6A-6E show an exemplary image review mode of an embodiment of an apparatus for inspecting optical fibers.

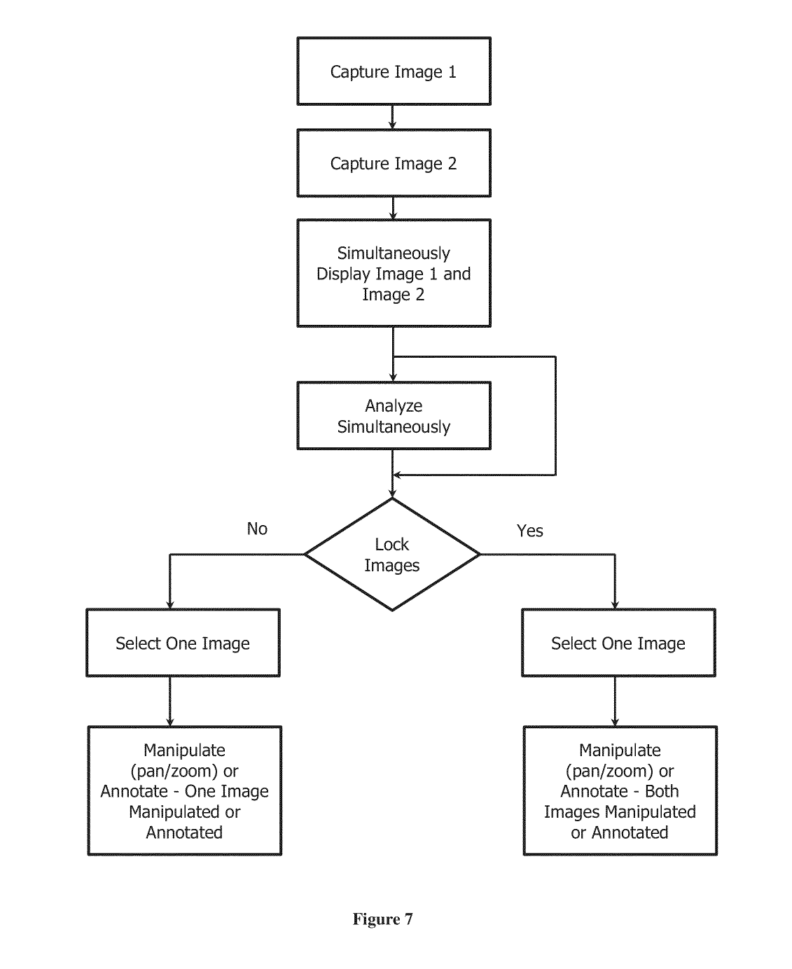

FIG. 7 shows an exemplary algorithm for implementing analysis, manipulation and/or annotation of a pair of images. First, a first image is captured and then a second image is captured using the image capture mode. Then, under processor control, the first and second images are simultaneously displayed. At this point, the images can be simultaneously analyzed with the analysis mode, or this step can be skipped. Next, the user decides if the user wants to manipulate (pan/zoom) or annotate one image or both images by selecting lock or unlock images. If the images are unlocked, one image is selected and then that image is manipulated or annotated. If the images are locked, one image is selected and then both images are simultaneously manipulated or annotated.

As mentioned above, although the exemplary embodiments described above are various apparatuses for inspecting optical fibers, they are merely exemplary and the general inventive concept should not be limited thereto, and it could also apply to other types of apparatuses for inspecting optical fibers.

What is claimed:

1. An optical fiber inspection apparatus comprising:
a memory configured to store a pair of images of ends of optical fibers;
a display; and
a processor coupled to said memory and said display;
wherein said processor controls said display to display said pair of images simultaneously.

2. The optical fiber inspection apparatus of claim 1, wherein said processor controls said display to manipulate both images simultaneously.

3. The optical fiber inspection apparatus of claim 1, wherein said processor controls said display to annotate both images simultaneously.

4. The optical fiber inspection apparatus of claim 1, wherein said processor controls said display to manipulate only one of said images.

5. The optical fiber inspection apparatus of claim 1, wherein said processor controls said display to annotate only one of said images.

6. The optical fiber inspection apparatus of claim 1, wherein said processor performs an analysis on both images and controls said display to display results of said analysis.

7. The optical fiber inspection apparatus of claim 2, wherein said manipulation is at least one of a zoom or pan.

8. The optical fiber inspection apparatus of claim 4, wherein said manipulation is at least one of a zoom or pan.

9. The optical fiber inspection apparatus of claim 6, wherein said processor outputs said results of said analysis.

10. A non-transitory computer readable recording medium storing an optical fiber inspection program used in an optical fiber inspection apparatus with a memory, display and processor coupled to the memory and display, the program causing the processor to control:
said display to display a pair of images of ends of optical fibers stored in said memory simultaneously.

11. The non-transitory computer readable recording medium of claim 10 wherein the program further causes said processor to control said display to manipulate both images simultaneously.

12. The non-transitory computer readable recording medium of claim 10 wherein the program further causes said processor to control said display to annotate both images simultaneously.

13. The non-transitory computer readable recording medium of claim 10 wherein the program further causes said processor to control said display to manipulate only one of said images.

14. The non-transitory computer readable recording medium of claim 10 wherein the program further causes said processor to control said display to annotate only one of said images.

15. The non-transitory computer readable recording medium of claim 10 wherein the program further causes said processor to perform an analysis on both images and controls said display to display results of said analysis.
